(19) United States
(12) Patent Application Publication
(10) Pub. No.: US 2025/0164522 A1
(43) Pub. Date: May 22, 2025

(54) SCANNING PROBE MICROSCOPE

(71) Applicant: SHIMADZU CORPORATION, Kyoto-shi (JP)

(72) Inventor: Masato HIRADE, Kyoto-shi (JP)

(21) Appl. No.: 18/708,181

(22) PCT Filed: Jul. 27, 2022
(86) PCT No.: PCT/JP2022/028894

§ 371 Date: Nov. 22, 2024

(30) Foreign Application Priority Data
Nov. 8, 2021 (JP) 2021-181933

(51) Int. Cl. G01Q 10/02

(52) U.S. Cl. CPC G01Q 10/02

(57) ABSTRACT

The control device (100) controls the deflection amount (D2), which is the pressing amount, to a deflection amount (D1), which is a target value (DT), based on the set value (DS1, DS2) of the pressing amount when pressing the cantilever (12) against the sample (S) when measuring the force curve, and changing the set value (DS1) to the set value (DS2) based on the deflection amount (D3), which is differential data indicating the difference between the deflection amount (D1), which is the target value (DT), and the deflection amount (D), which is the actual pressing amount, in a previously performed force curve measurement when measuring the force curve.

### TECHNICAL FIELD

The present invention relates to a scanning probe microscope.

### BACKGROUND ART

In a scanning probe microscope, a cantilever provided with a probe is positioned to face the sample. In a scanning probe microscope, a sample is observed in a state in which a cantilever and the sample are brought close to each other. As one example of a conventional scanning probe microscope, there is a scanning probe microscope that allows the probe to be stably mounted and maintained at a weak interatomic force position on the force curve (see Patent Document 1). A force curve represents data showing the relation between the distance between the probe and the sample, and the force (deflection amount of the cantilever) acting between the cantilever and the sample.

In a conventional scanning probe microscope, it is possible to measure a force curve in the process of pressing the cantilever against the sample and subsequently retracting the cantilever from the sample. In a scanning probe microscope, once the force curve is measured, information about the sample, such as the elastic modulus of the sample, can be obtained based on the measured force curve.

In a conventional scanning probe microscope, when measuring a force curve, the target value of the pressing amount (deflection amount of the cantilever) of the cantilever on the sample is set as a set value to be controlled by the control device of the scanning probe microscope. In a scanning probe microscope, when measuring a force curve, while detecting the pressing amount applied by the cantilever to the sample (hereinafter referred to as the “pressing amount”), the control device performs the operation to bring the probe and the sample closer together until the detection value of the pressing amount of the cantilever on the sample reaches the set value. Upon reaching this set value, it then performs the operation to move the probe and the sample apart. Through this control, a force curve is obtained.

### PRIOR ART DOCUMENT

### Patent Document

Patent Document 1: Japanese Patent No. 3883790

### SUMMARY OF THE INVENTION

### Problems to be Solved by the Invention

In a conventional scanning probe microscope, when measuring a force curve, the control device was controlled to start moving the probe and the sample away from each other when the detection value of the pressing amount has reached a set value.

However, for example, in a situation in which the speed at which the sample and the cantilever are brought closer to each other is higher than a reference speed, even if the control device executes control to start a movement to move the probe and the sample away from each other when the detected value of the pressing amount (deflection amount of the cantilever) has reached a set value, there will be a time difference between the timing at which the detection of the pressing amount has reached the set value and the timing at which the movement to bring the probe and the sample closer to each other actually stops.

When such a time difference in control occurs, there is a noticeable difference between the target value of the pressing amount and the actual pressing amount when measuring the force curve.

The present invention has been made to solve such problems, and its purpose is to reduce the difference between the target value of the pressing amount and the actual pressing amount when the cantilever is pressed against a sample when measuring a force curve.

### Means for Solving the Problems

A scanning probe microscope according to one aspect of the present invention is provided with a sample stage configured to place a sample thereon, a cantilever provided with a probe, and a control device. The cantilever is positioned to face the sample stage. The control device is configured to control a pressing amount of the cantilever against the sample to a target value based on a set value of the pressing amount, when measuring a force curve, and change the set value based on differential data indicating a difference between the target value in a previously performed force curved measurement and an actual pressing amount, when measuring the force curve.

### Effects of the Invention

When measuring a force curve, the difference between the target value of the pressing amount and the actual pressing amount when pressing the cantilever against a sample can be reduced.

### BRIEF DESCRIPTION OF THE DRAWINGS

FIG. 1 is a diagram showing a main structure and a control circuit of a scanning probe microscope 1.

FIG. 2 is a diagram showing the operation state of the scanning probe microscope 1 over time when measuring a force curve.

FIG. 3 is a diagram showing a measurement example of a force curve.

FIG. 4 is a diagram showing a measurement example of a force curve divided into an approach line A and a release line B.

FIG. 5 is a diagram showing a method for adjusting a set value DS for the maximum value of the deflection amount D in the case where the maximum value of the deflection amount D has exceeded the target value DT on the approach line A.

FIG. 6 is a diagram showing a method for adjusting a set value DS for the maximum value of the deflection amount D in the case where the maximum value of the deflection amount D falls short of the target value DT on the approach line A.

FIG. 7 is a flowchart of a set value adjustment processing at the time of measuring a force curve.

### EMBODIMENTS FOR CARRYING OUT THE INVENTION

Hereinafter, some embodiments of the present invention will be described with reference to the attached drawings. Note that, hereinafter, the same or equivalent part in the figures is assigned by the same reference symbol, and the description thereof will not be repeated.

### [Main Structure and Configuration of Control Circuit of Scanning Probe Microscope 1]

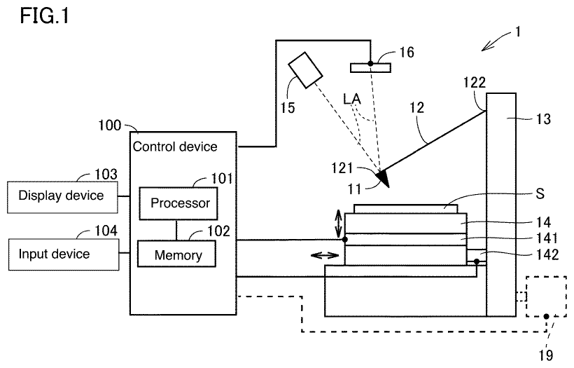

FIG. 1 is a diagram showing a main structure and a control circuit of a scanning probe microscope 1. In FIG. 1, the main structure of the scanning probe microscope 1 is shown in a side view, and the control circuit is illustrated in a block diagram.

In the following description, the ground plane of the scanning probe microscope 1 is referred to as the XY plane, and the axis perpendicular to the XY plane is defined as the Z axis.

Referring to FIG. 1, the scanning probe microscope 1 is equipped, as its principal constituent elements, with a cantilever 12, a support device 13, a sample stage 14, a laser light source 15, a photodetector 16, a Z-directional actuator 141, an X-Y directional actuator 142, and a control device 100.

A sample S is placed on the sample stage 14. Below the sample stage 14, a Z-directional actuator 141 is provided to move the sample stage 14 in the vertical direction (Z-direction). Below the Z-directional actuator 141, an X-Y directional actuator 142 is provided to move the sample stage 14 and the Z-directional actuator 141 in the X-Y direction.

The Z-directional actuator 141 and the X-Y directional actuator 142 constitute a repositioning device. The Z-directional actuator 141 and the X-Y directional actuator 142 both have piezoelectric elements. The Z-directional actuator 141 and the X-Y directional actuator 142 are controlled in their positions in the Z-direction and the X-Y direction, respectively, by the voltage applied to their piezoelectric elements.

The cantilever 12 is provided to be positioned above the sample S placed on the sample stage 14 at the time of measuring the sample S. The cantilever 12 has a probe 11 on its surface, which is the surface facing the sample S, at the tip portion 121, which is the one end side. The cantilever 12 is fixed at its rear end portion 122, on the other end side, to a support device 13 that extends in the Z-direction. The cantilever 12 is capable of bending in the Z-direction due to its flexibility, for example, when pressed against a sample S, for example.

Above the cantilever 12, a laser light source 15 and a photodetector 16 are provided. The laser light source 15 irradiates laser light LA toward the rear surface side of the tip portion 121 of the cantilever 12 during the measurement of the sample S. The rear surface of the cantilever 12 is a surface on the side opposite to the surface side facing the sample S.

The photodetector 16 is a sensor for detecting laser light. The photodetector 16 is provided at a position where it can receive the laser light LA reflected from the rear surface of the tip portion 121 of the cantilever 12. The photodetector 16 receives and detects the laser light LA reflected from the rear surface of the tip portion 121 of the cantilever 12.

Note that as a device for changing the distance between the sample S and the tip portion 121 of the cantilever 12, a movable support device 13 that moves the cantilever 12 in the Z-direction may be used in addition to the Z-directional actuator 141 that moves the sample stage 14 in the Z-direction, as shown by the solid lines in FIG. 1.

Such a movable support device 13 is equipped with, inside the support device 13, a motor 19 as shown in the dashed lines, a conversion mechanism that converts the rotational motion of a gear attached to the drive shaft of the motor 19 into a linear motion in the Z-direction, and a movable body provided on the upper part of the conversion mechanism, similar to a rack-and-pinion mechanism. To the moving body, the rear end portion 122 of the cantilever 12 is fixedly attached. It is sufficient to configure such that the cantilever 12 moves in the Z-direction as the moving body moves in the Z-direction.

As a device for changing the distance between the sample S and the tip portion 121 of the cantilever 12, it may be configured such that only the Z-directional actuator 141 is provided, only the movable support device 13 is provided, or both of these two devices are provided.

The control device 100 is embodied by hardware, such as a CPU (Central Processing Unit) and a memory, and by software that performs the arithmetic operations described below.

The control device 100 controls the operation of each of the parts constituting the scanning probe microscope 1. The control device 100 is configured, for example, according to a general-purpose computer architecture. Note that the control device 100 may be implemented in the scanning probe microscope 1 using dedicated hardware. The control device 100 is equipped with a processor 101 and a memory 102. The control device 100 is connected to a display device 103 and an input device 104.

Note that the control device 100 may be configured to include a display device 103 and an input device 104, in addition to the processor 101 and the memory 102.

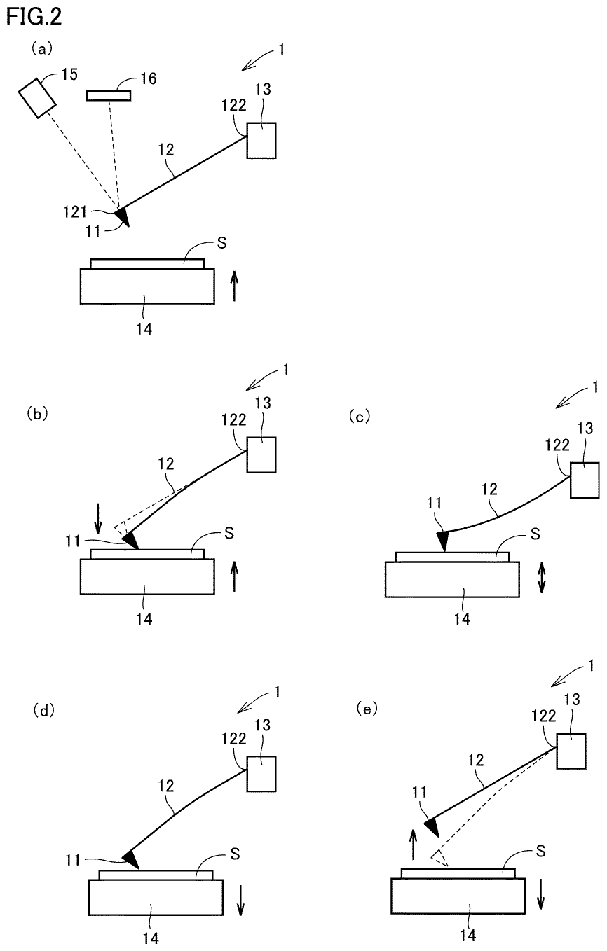

The processor 101 is typically a computation processing unit, such as a CPU (Central Processing Unit) and an MPU (Multi Processing Unit). The processor 101 reads and executes programs stored in the memory 102 to realize each of the processing of the control device 100 described below. Although the example shown in FIG. 2 shows a configuration with a single processor, the control device 100 may have a plurality of processors.

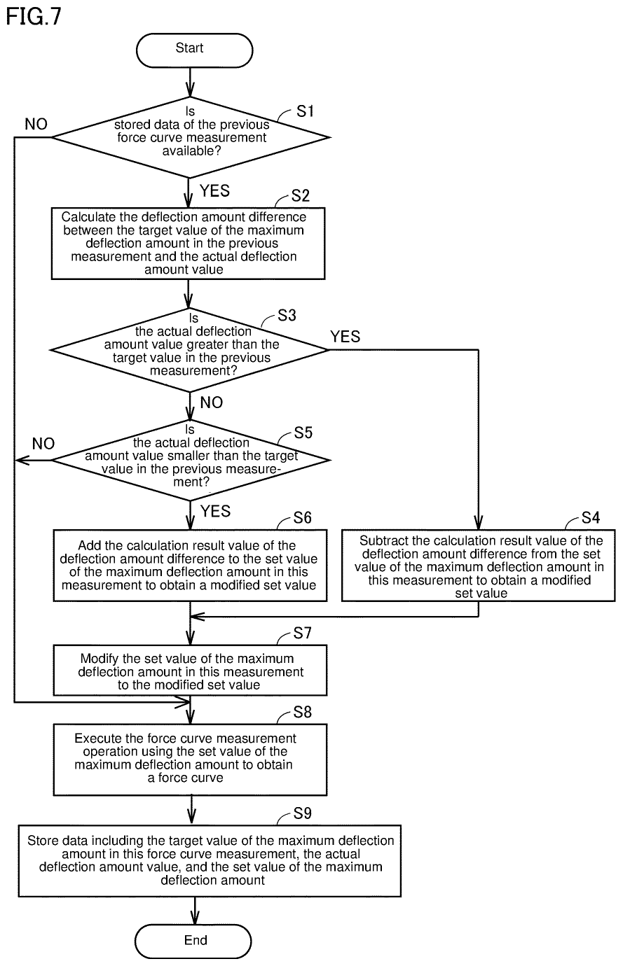

The memory 102 is realized by a RAM (Random Access Memory), and a non-volatile memory, such as a ROM (Read Only Memory) and a flash memory. The memory 102 stores programs to be executed by the processor 101, and data to be used by the the processor 101. For example, the memory 102 stores various programs, such as programs for executing the processing shown in FIG. 7.

Note that the memory 102 may be a CD-ROM (Compact Disc-Read Only Memory), a DVD-ROM (Digital Versatile Disk-Read Only Memory), a USB (Universal Serial Bus) memory, a memory card, an FD (Flexible Disk), a hard disk, an SSD (Solid State Drive), a magnetic tape, a cassette tape, an MO (Magnetic Optical Disc), an MD (Mini Disc), an IC (Integrated Circuit) card (excluding memory cards), an optical card, a mask ROM, or an EPROM, as long as the memory can non-temporarily record programs in a format readable by the control device 100.

The display device 103 is configured using a liquid crystal display panel or the like. The display device 103 displays, for example, a setting screen for making various settings for measurement with the scanning probe microscope 1, a screen showing the state during measurement with the scanning probe microscope 1, and a screen displaying the measurement results measured with the scanning probe microscope 1.

The input device 104 is composed of a mouse, a keyboard, etc. The input device 104 is an input interface that accepts information entered through the input device 104. Note the control device 100 may be equipped with a touch panel that integrates the display device 103 and the input device 104.

The control device 100 sends a control signal to the optics drive device, the illustration of which is omitted. The optical drive device drives the laser light source 15 and the photodetector 16 in response to the control signal. With this, the emission control and the position control of the laser light source 15 are performed, and the position control of the photodetector 16 is performed. The photodetector 16 outputs detection information on the laser light LA to the control device 100.

The control device 100 sends a control signal to the actuator drive device, which is not illustrated, and the actuator drive device applies a voltage to the piezoelectric elements of the Z-directional actuator 141 and the X-Y directional actuator 142 in response to the control signal, thereby performing the control to drive the Z-directional actuator 141 and the X-Y directional actuator 142. This allows the control device 100 to perform control to change the relative positional relation between the cantilever 12 and the sample S.

The control device 100 sends a control signal to the actuator drive device, which is not illustrated, and the actuator drive device applies a voltage to the piezoelectric elements of the Z-directional actuator 141 and the X-Y directional actuator 142 in response to the control signal, thereby controlling the Z-directional actuator 141 and the X-Y directional actuator 142.

The control device 100 identifies the incident position of the laser light LA detected by the photodetector 16 based on the detection information input from the photodetector 16, and calculates the Z-directional position of the tip portion 121 of the cantilever 12, or the deflection amount D of the cantilever 12 in the Z-direction, based on that incident position.

In the case where a movable support device 13 that moves the cantilever 12 in the Z-direction is used as a device to change the distance between the sample S and the tip portion 121 of the cantilever 12, the control device 100 drives and controls the motor 19, as indicated by dashed lines.

### [Measurement Method of Force Curve]

Next, the method for measuring a force curve with the scanning probe microscope 1 will be described.

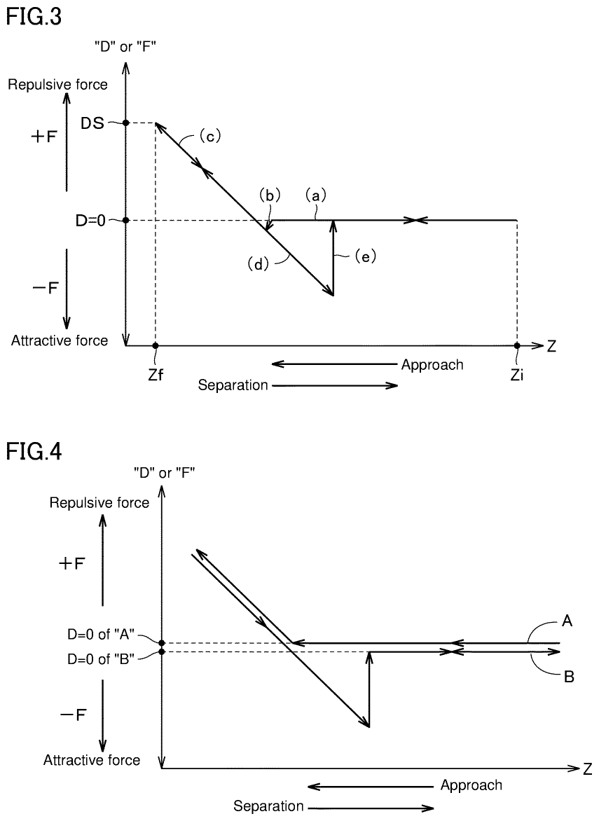

FIG. 2 is a diagram showing the operation state of the scanning probe microscope 1 when measuring a force curve over time. FIG. 3 is a diagram showing a measurement example of a force curve.

As shown in FIGS. 2(a) to 2(e), during the measurement of a force curve, the sample stage 14 is moved in the Z-direction by the Z-directional actuator 141. This changes the Z-directional position of the rear end portion 122 relative to the surface of the sample S.

The control device 100 determines the position Z1 of the rear end portion 122 in the Z-direction based on the voltage value applied to the piezo element of the Z-directional actuator 141. The position at which the laser light LA enters the photodetector 16 differs depending on the Z-directional position of the tip portion 121 of the cantilever 12. This allows the control device 100 to obtain the Z-directional position Z2 of the tip portion 121 by detecting the incident position of the laser light LA. Thus, the control device 100 calculates the Z-directional position Z1 of the tip portion 121 and the Z-directional position Z2 of the rear end portion 122 of the cantilever 12. Based on the difference (Z1−Z2) between them, the deflection amount D of the cantilever 12 is calculated.

The deflection amount D of the cantilever 12 is also data that can identify the pressing amount when the cantilever 12 is pressed against the sample S.

When measuring a force curve, as shown in FIG. 3, the control device 100 moves the sample stage 14 so that the probe 11 approaches the surface of the sample S, from the initial position Zi to the maximum position Zf of the deflection amount D, where it becomes the set value DS of the maximum value of the deflection amount D of the cantilever 12. The control device 100 then moves the sample stage 14 so that the position of the rear end portion 122 of the cantilever 12 in the Z-direction returns to the initial position Zi.

As described above, the movement range of the sample stage 14 in the Z-direction is conditioned to be between the above-mentioned initial position Zi and the above-mentioned maximum position Zf. In addition to the condition for the movement range, a limit position, which is the movement limit of the sample stage 14, is set at a position in the Z-direction to prevent the probe 11 from colliding with the sample stage 14 when the sample S is not placed on the sample stage 14 in the case of a malfunction of the sample stage 14. In other words, if the deflection amount D of the cantilever 12 does not reach the set value DS of the maximum deflection amount even after the Z-directional position of the sample stage 14 reaches the limit position, the control device 100 moves the sample stage 14 to return to the initial position Zi without reaching the maximum position Zf.

In the following description, the deflection amount D is defined as follows, where the initial position Z1i is the initial position of the tip portion 121 in the Z-direction when there is no deflection of the cantilever 12, and Z1 is the actual position of the tip portion 121 during the force curve measurement. For example, if the direction from the cantilever 12 towards the sample stage 14 is defined as the positive direction of the Z-direction coordinates, and Z0 is defined as the difference Z1i−Z2 in the positive direction of the Z-direction coordinates between the initial Z-directional position Z1i of the tip portion 121 and the Z-directional position Z2 of the rear end portion 122, which is fixed, then the deflection amount D is defined by D=(Z0−(Z1−Z2)). As a result, when the cantilever 12 is bent so that the tip portion 121 is raised when viewed from the side, because the actual position Z1 of the tip portion 121 moves in the negative direction relative to the initial position Z1i in the Z-directional coordinates, resulting in Z0>(Z1−Z2), and therefore, the deflection amount D becomes positive. On the other hand, when the cantilever 12 is bent so that the tip portion 121 is lowered when the cantilever 12 is viewed from the side, the position Z1 of the actual tip portion 121 is moved in a positive direction from the initial position Z1i in the Z-directional coordinates, resulting in Z0<(Z1−Z2), and therefore the deflection amount D becomes negative.

In FIG. 3, the vertical axis of the force curve indicates the deflection amount D of the cantilever 12 or the force F acting on the cantilever 12. In FIG. 3, the horizontal axis of the force curve indicates the Z-axis directional position Z of the rear end portion 122 of the cantilever 12. As shown on the vertical axis in FIG. 3, the deflection amount D of the cantilever 12 is positive when a repulsive force acts and negative when an attractive force acts.

To measure a force curve, initially, as shown in FIG. 2(a), the sample stage 14 is moved upward from its initial position, and the tip of the probe 11 is brought closer to the surface of the sample S. During the period when the distance between the tip of the probe 11 and the surface of the sample S is somewhat large, the interatomic force between the tip of the probe 11 and the surface of the sample S is negligibly small, so the deflection amount D is continuously zero from the initial position Zi as shown in the section (a) in FIG. 3.

As shown in FIG. 2(b), when the tip of the probe 11 and the surface of the sample S further approach each other, the van der Waals force, which is the interatomic force between the tip of the probe 11 and the surface of the sample S, becomes large enough to be non-negligible. Consequently, as shown in FIG. 2(b), the cantilever 12 bends in the direction that the tip portion 121 is lowered due to the attractive force. The deflection amount of the cantilever 12 in that case becomes a negative value, as shown in the section (b) of FIG. 3.

As shown in FIG. 2(c), when the sample stage 14 is moved further upward, the rear end portion 122 of the cantilever 12 approaches the surface of the sample S in a state in which the tip portion of the probe 11 is in contact with the surface of the sample S. As a result, as shown in FIG. 2(c), the cantilever 12 bends in the direction that the tip portion 121 is raised, opposite to that in FIG. 2(b). The deflection amount D of the cantilever 12 in such a case becomes a positive value as shown in the section (c) in FIG. 3, and the cantilever 12 deflects such that the absolute value of the deflection amount D increases as the tip of the probe 11 is pressed against the surface of the sample S. As the tip of the probe 11 is pressed against the surface of the sample S, the tip of the probe 11 is subjected to a reaction force, or a repulsive force, from the surface of the sample S.

When the deflection amount D of the cantilever 12 reaches the preset maximum set value DS, as shown in the section (c) of FIG. 3, the movement direction of the sample stage 14 is switched from upward to downward, as shown in FIGS. 2(c) and (d). As a result, the deflection amount D begins to decrease, as shown in FIG. 3. As shown in FIG. 3, the rear end portion 122 of the cantilever 12 has reached the maximum position Zf when the deflection amount D of the cantilever 12 reaches the predetermined maximum set value DS.

When the sample stage 14 moves downward, the rear end portion 122 of the cantilever 12 moves away from the surface of the sample S with the tip of the probe 11 initially in contact with the surface of the sample S. In the cantilever 12, the tip of the probe 11 adheres to the surface of the sample S due to the adhesiveness of the surface of the sample S.

Due to such an adhesiveness of the surface of the sample S, even if the tip of the probe 11 is no longer subjected to the repulsive force from the surface of the sample S during the downward movement of the sample stage 14, the tip of the probe 11 does not immediately detach from the surface of the sample S, and for a while, as shown in FIG. 2(d), the cantilever 12 bends in the direction that its tip portion 121 moves downward. The deflection amount D of the cantilever 12 in such a case becomes a negative value as shown in the section (d) in FIG. 3, and the cantilever 12 deflects such that the absolute value of the deflection amount D increases as the tip of the probe 11 is pressed against the surface of the sample S. As the rear end portion 122 of the cantilever 12 moves away from the surface of the sample S, the tip of the probe 11 receives an attractive force from the surface of the sample S.

Thereafter, as the deflection amount of the tip portion 121 of the cantilever 12 in the downward direction increases, an upward force acts on the tip of the probe 11 based on the elastic force caused by the deflection, and the tip of the probe 11 detaches from the surface of the sample S, as shown in FIG. 2(e). When the tip of the probe 11 detaches from the surface of the sample S, the deflection of the cantilever 12 decreases rapidly, and the deflection amount D becomes 0, as shown in the section (e) of FIG. 3.

Through the series of operations described above in FIG. 2(a) to (e), a force curve as shown in FIG. 3 is obtained at a single point on the surface of sample S. Such a force curve measurement is performed in the same manner at several locations on the surface of the sample S. With this, for one sample S, the force curve is measured continuously at a plurality of locations.

The force curve measured in this manner includes, for example, the following information about the surface of the sample S. The force curve obtained in the section (c) of FIG. 3 represents the flexibility of the surface of the sample S. The smaller the deflection amount D, which changes as the rear end portion 122 of the probe 11 in the cantilever 12 approaches the surface of the sample S, the greater the flexibility of the sample S. In other words, in the section (c) of FIG. 3, the smaller the inclination of the force curve, the greater the flexibility of the sample S. The closer the position where the deflection amount D decreases rapidly in the section (d) in FIG. 3 is to the right side of the horizontal axis of the force curve, the greater the adhesion force of the sample S to the probe 11.

### [Adjustment of Set Value for Maximum Value of Deflection Amount D During Force Curve Measurement]

Next, the method for adjusting the set value DS for the maximum value of the deflection amount D when measuring a force curve with the scanning probe microscope 1 will be described.

The adjustment of the set value DS described below is effective for the case in which a measurement of a force curve is performed a plurality of times on a single sample, the case in which a measurement of a force curve is performed a plurality of times on a plurality of samples of the same type, and the case in which a force curve is measured on a single sample or a plurality of samples of similar flexibility, such as a sample of different types but of similar flexibility.

In the following description, a method for adjusting the set value DS for the maximum value of the deflection amount D will be described using an example of a force curve in the case where no pulling force acts on the cantilever 12, as shown in the section (b) of FIG. 3. The reason for using an example of a force curve in which no attractive force acts on the cantilever 12, such as the section (b) in FIG. 3, is to simplify the description.

### <Approach Line and Release Line on Force Curve>

FIG. 4 is a diagram showing a measurement example of a force curve, divided into an approach line A and a release line B.

The force curve in FIG. 4 differs from the force curve in FIG. 3 as follows. The force curve shown in FIG. 4 represents a force curve in the scenario where an attractive force does not act on the cantilever 12, similar to the section (b) in FIG. 3. For the force curve shown in FIG. 4, the position of the origin of the vertical axis (D=0) is intentionally differentiated to facilitate distinguishing between the approach line A and the release line B in the drawing.

The approach line A and the release line B are shown in FIG. 4 to describe the method for adjusting the set value DS for the maximum value of the deflection amount D using the approach line A below.

The force curve can be shown by dividing it into the approach line A and the release line B. The approach line A represents data on the force curve corresponding to the approach process, which involves reducing the distance between the cantilever 12 and the sample stage 14. The release line B represents data on the force curve corresponding to the line of the release process, which involves increasing the distance between the cantilever 12 and the sample stage 14. In the following, the method for adjusting the set value DS for the maximum value of the deflection amount D will be described using the approach line A.

### <When Maximum Value of Deflection Amount D Exceeds Target Value DT>

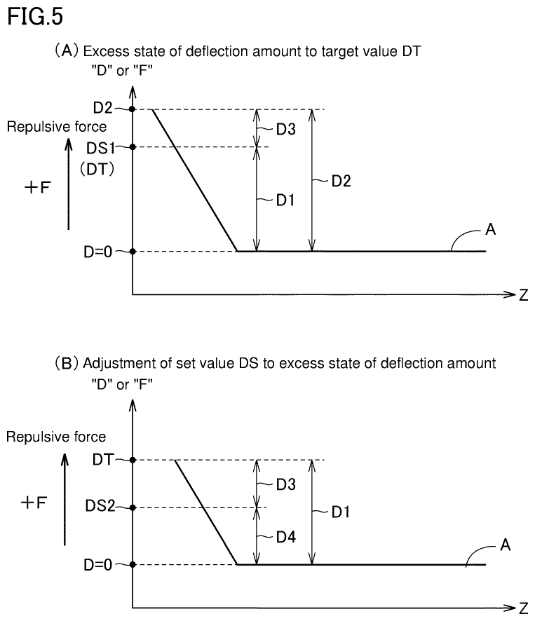

FIG. 5 is a diagram showing a method for adjusting a set value DS for the maximum value of the deflection amount D in the case where the maximum value of the actual deflection amount D exceeds the target value DT on the approach line A.

FIG. 5(A) shows an example of the approach line A in the exceedance state in which the maximum value of the actual deflection amount D exceeds the target value DT. FIG. 5(B) shows an example of adjusting the set value DS for the maximum value of the deflection amount D in response to the exceedance state depicted in FIG. 5(A), as well as an example of the approach line A after the adjustment.

Referring to FIG. 5(A), in the control device 100, the target value DT for the maximum value of the deflection amount D is set as the set value DS1. The target value DT is the deflection amount D1. In the control device 100, the data for the target value DT (=deflection amount D1) entered from the input device 104 is set as the set value DS1 for the maximum value of the deflection amount D. At the time of measuring the force curve, the control device 100 performs control to switch the movement direction of the sample stage 14 from upward to downward, as shown in FIG. 2(c), when the deflection amount D, which is detected as described above, increases in the manner of the approach line A and reaches the set value DS1.

However, due to reasons such as the relatively high movement speed of the sample stage 14, it may be difficult for the sample stage 14 to stop promptly at the moment the control to switch its movement direction is executed. As a result, as shown in FIG. 5(A), the maximum value D2 of the actual deflection amount may exceed the target value DT, that is, the set value DS1. FIG. 5(A) shows that the maximum value D2 of the actual deflection amount exceeds the deflection amount D1, which is the target value DT set as the set value DS1, by the deflection amount D3.

As shown in FIG. 5(A), if the maximum value D2 of the actual deflection amount exceeds the deflection amount D1, which is the target value DT set as the set value DS1 for the maximum value of the deflection amount, by the deflection amount D3, the control device 100 performs an adjustment of the set value DS for the maximum value of the deflection amount to change it to the set value DS2 for the next force curve measurement as shown in FIG. 5(B). This set value DS2 is set to reflect a deflection amount D4, which is reduced by the deflection amount D3 from the target value DT.

When the adjustment of the set value DS is performed as shown in FIG. 5(B), the control device 100 executes the switching control of the movement direction of the sample stage 14 when the detected deflection amount D has reached the set value DS2, where data for a deflection amount D4, which is smaller by the deflection amount D3 than the target deflection amount D1 (a target value DT). In that case, when the deflection amount D during the force curve measurement exceeds the deflection amount D4, observed at the time of switching control of the movement direction of the sample stage 14, by the deflection amount D3 predicted to be exceeded during the previous force curve measurement, it can reach the deflection amount D1, which is the target value DT.

As described above, when measuring the force curve, as shown in FIG. 5(A), regarding the maximum value of the deflection amount in the force curve measurement conducted previously, as shown in FIG. 5(B), the set value DS for the maximum value of the deflection amount is adjusted based on the deflection amount D3, which is the differential data showing the difference between the target deflection amount D1, as the target value DT, and the maximum actual deflection amount D2. Specifically, when the detected deflection amount D reaches the set value DS for the maximum value, the control device 100 performs control to switch the movement direction of the sample stage 14, and then changes the set value DS for the maximum value of the deflection amount, anticipating that the actual deflection amount D will exceed by the difference data, which is the deflection amount D3. Specifically, when the deflection amount exceeds the set value DS2 by the difference data, that is, the deflection amount D3, the control device 100 sets a value such that it achieves the target value DT, namely, the data of the deflection amount D4, which is “DT−D3=DS2,” as the adjusted set value DS2.

When measuring the force curve, the control device 100 changes the set value DS1 to the set value DS2 based on the deflection amount D3, which is the differential data indicating the difference between the target deflection amount D1, which is the target value DT, and the actual deflection amount D2, derived from a previously conducted force curve measurement. This enables a reduction in the difference between the target deflection amount D1, which is the target value DT when pressing the cantilever 12 against the sample S, and the actual deflection amount D2.

The control device 100 reduces the set value DS1 to DS2 when the maximum value D2 of the actual deflection amount exceeds the deflection amount D1, which is a target value DT, thereby enabling the adjustment of the set value from DS1 to DS2 so that the actual deflection amount D2 becomes equal to the target deflection amount D1.

### <When Maximum Value of Deflection Amount D Fall Short of Target Value DT>

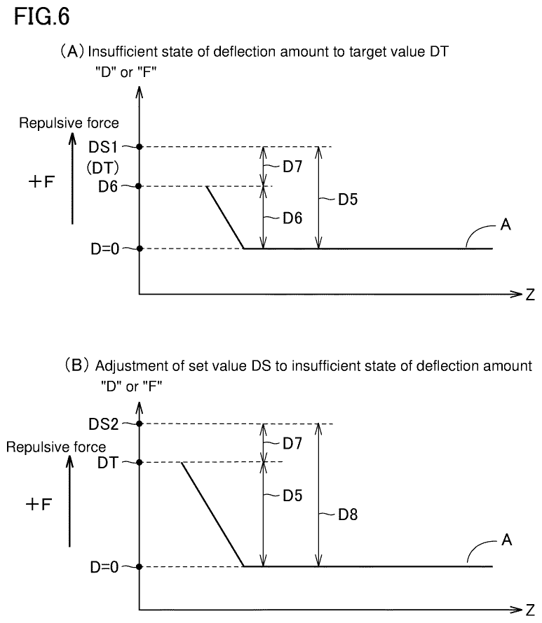

FIG. 6 is a diagram showing a method for adjusting the set value DS for the maximum value of the deflection amount D in the case where the maximum value of the actual deflection amount D falls short of the target value DT on the approach line A.

FIG. 6(A) shows an example of the approach line A in a deficiency state in which the maximum value of the actual deflection amount D falls short of the target value DT. FIG. 6(B) shows an adjustment example of the set value DS for the maximum value of the deflection amount D for the deficient state as shown in FIG. 6(A) and an example of the approach line A after the adjustment.

Referring to FIG. 6(A), in the control device 100, the target value DT for the maximum value of the deflection amount D is set as the set value DS1. The target value DT is the deflection amount D5. In the control device 100, the data for the target value DT (=deflection amount D5) entered from the input device 104 is set as the set value DS1 for the maximum value of the deflection amount D. At the time of measuring the force curve, the control device 100 performs control to switch the movement direction of the sample stage 14 from upwards to downwards as shown in FIG. 2(c) when the deflection amount D, which is detected as previously described, increases similar to the approach line A and reaches the set value DS1.

However, in the case where the deflection amount D of the cantilever 12 fails to reach the set value DS1 of the maximum value of the deflection amount D even after the Z-directional position of the sample stage 14 reaches the limit position as previously described, the control device 100 initiates control to move the sample stage 14 back to its initial position Zi. When such control is executed, as shown in FIG. 6(A), the maximum value D6 of the actual deflection amount D falls short of the target value DT, that is, the deflection amount D5, which is the set value DS1. FIG. 6(A) shows the state in which the maximum value D6 of the actual deflection amount falls short of the deflection amount D5, which is the target value DT set as the set value DS1, by the deflection amount D7.

As shown in FIG. 6(A), in the case where the maximum value D6 of the actual deflection amount D falls short of the deflection amount D5, which is the target value DT set as the set value DS1, by the deflection amount D7 due to insufficient driving force in the Z-direction by the Z-directional actuator 141 or other reasons, the control device 100 performs adjustment of the setting for the next measurement of the force curve. It changes the set value DS for the maximum value of the deflection amount D to the set value DS2 in which the data for the deflection amount D8, which is greater by the deflection amount D7 than the deflection amount D5 is set, as shown in FIG. 6(B).

When the set value DS is adjusted as shown in FIG. 6(B), the control device 100 executes switching control of the movement direction of the sample stage 14 when the detected deflection amount D reaches the set value DS2. This set value DS2 is defined by the data for the deflection amount D8, which is greater by the deflection amount D7 than the target value DT, which is the deflection amount D5. In that case, if the deflection amount D, measured during the force curve measurement, falls short by the previously predicted insufficient deflection amount D7 from the deflection amount D8, at which the switching control of the movement direction of the sample stage 14 is executed, it could result in the deflection amount D5, which is the target value DT.

Thus, when measuring the force curve, as shown in FIG. 6(A), the set value DS for the maximum value of the deflection amount is changed based on the deflection amount D7, which is the differential data indicating the difference between the deflection amount D5, the target value DT, and the maximum value of the actual deflection amount D6, as illustrated in FIG. 6(B). Specifically, the control device 100 anticipates that the deflection amount D at the time of the measurement of the force curve will fall short of the deflection amount D8, required for executing the switching control of the movement direction of the sample stage 14, by the deflection amount D7, which is the differential data. It then sets the data for the deflection amount D8, which ensures that the deflection amount reaches the target value DT for the maximum value of the deflection amount when it falls short of the set value DS2 by the deflection amount D7, namely, “DT+D7=DS2,” as the adjusted set value DS2.

When measuring the force curve, the control device 100 changes the set value DS1 to DS2 based on the deflection amount D7, which is the differential data representing the difference between the target deflection amount D5, which is the target value DT, and the actual deflection amount D6 of the actual deflection amount D from previous force curve measurements. This enables a reduction in the difference between the target deflection amount D5, which is the target value DT, when pressing the cantilever 12 against the sample S and the actual deflection amount D6.

The control device 100 lowers the set value DS1 to DS2 when the maximum value D6 of the actual deflection amount falls short of the deflection amount D5, which is the target value DT, thereby allowing the adjustment of the set value from DS1 to DS2 to ensure that the maximum value D6 of the actual deflection amount matches the deflection amount D5, which is the target value DT.

[Set Value Adjustment Processing for Maximum Value of Deflection Amount D when Measuring Force Curve]

Referring to FIG. 7, the set value adjustment processing for the maximum value of the deflection amount D at the time of measuring the force curve will be described.

FIG. 7 is a flowchart of the set value adjustment processing during a force curve measurement. The program that executes the set value adjustment processing at the time of measuring the force curve is stored in the memory 102 of the control device 100 and is executed by the processor 101.

The processor 101 executes the following processing in the set value adjustment processing at the time of measuring the force curve.

In Step S1, it is determined whether there is stored data at the time of the previous measurement of the previous force curve. The term “previous” refers to the instance immediately preceding. The stored data from the time of the previous force curve measurement includes data of the target value for the maximum value of the deflection amount D from the previous measurement, data of the detection value of the actual deflection amount D, and the set value DS for the maximum value of the deflection amount D, all to be stored in the memory 102 as described later in Step S9.

In Step S1, if it is determined that no stored data from the previous force curve measurement is available, the process proceeds to Step S8, which is described later. On the other hand, in Step S1, if it is determined that stored data from the previous force curve measurement is available, the process proceeds to Step S2.

In Step S2, the stored data from the previous force curve measurement is retrieved. Based on the retrieved stored data, the calculation is made for the difference in deflection amount, which is the differential data between the target value DT for the maximum value of the deflection amount D from the previous force curve measurement and the detection value of the actual deflection amount D. The deflection amount difference calculated in Step S2 is, for example, a deflection amount D, such as the deflection amount D3 in FIG. 5 or the deflection amount D7 in FIG. 6.

In Step S3, based on the stored data retrieved in Step S2, it is determined whether, at the time of the previous force curve measurement, the actual detected deflection amount D was greater than the target value DT for the maximum value of the deflection amount D.

If it is determined in Step S3 that the detected value of the actual deflection amount D is greater, as exemplified in FIG. 5(A), then in Step S4, a calculation is performed. This calculation involves subtracting the calculation result value of the deflection amount difference, which is obtained as differential data from the calculation in Step S2, from the set value DS1. DS1 is the predetermined set value for the maximum previous deflection amount that was planned to be established during the current force curve measurement. As a result of this calculation, a modified set value DS2, as illustrated in FIG. 5(B), is obtained. In Step S4, for example, the deflection amount D4 is calculated by subtracting the deflection amount D3 from the deflection amount D1, which is the set value DS1 in FIG. 5, to obtain the deflection amount D4 as the set value DS2. After Step S4, the routine proceeds to Step S7.

On the other hand, if it is determined in Step S3 that the detection value of the actual deflection amount D was not larger, in Step S5, it is determined, based on the stored data read out in Step S2, whether the detection value of the actual deflection amount D was smaller than the target value DT for the maximum value of the deflection amount D during the previous force curve measurement.

When it is determined in Step S5 that the actual deflection amount D was not smaller, i.e., the set value DS1 for the maximum value of the deflection amount and the actual deflection amount D were identical, then it proceeds to Step S8. On the other hand, when it is determined in Step S5 that the actual deflection amount D was smaller, as exemplified in FIG. 6(A), in Step S6, a calculation is performed to subtract the deflection amount difference obtained as differential data from the calculation in Step S2, from the set value DS1, which is the predetermined set value for the maximum value of the previous deflection amount that is planned to be set for the current force curve measurement. As a result of this calculation, a modified set value DS2 is obtained as shown in FIG. 5(B). In Step S6, for example, a calculation is performed to obtain the deflection amount D8 as the set value DS2 by adding the deflection amount D7 to the deflection amount D5, which is the set value DS1 in FIG. 6. After Step S6, the routine proceeds to Step S7.

In Step S7, the set value for the maximum value of the deflection amount at the time of this force curve measurement is changed from the previous set value DS1 to the set value DS2 obtained in Step S4 or Step S6. Next, in Step S8, if the process proceeds from Step S1 to Step S8, the force curve measurement operation is executed using the set value DS1 for the maximum value. However, if the process proceeds from any of Steps S4 or S6 to Step S8, the force curve measurement operation is executed using the modified set value DS2 for the maximum value DS2, and thus, the force curve measurement data is acquired.

In Step S9, data including the data of the target value DT for the maximum value of the deflection amount during this force curve measurement, the data of the detection value of the actual deflection amount D, and the set value DS of the maximum value of the deflection amount are stored in the memory 102, and the process is completed. In this way, the data described in Step S9 is determined as the stored data from the previous force curve measurement in Step S1 at the time of the next force curve measurement.

By executing the processes described above, it becomes possible to adjustment the set value for the maximum value of the deflection amount during force curve measurements. This adjustment is based on differential data that reflects the difference between the target value of the maximum deflection amount from previous measurements and the actual deflection amount. More specifically, based on the differential data that indicates the difference between the target value for the maximum deflection amount from past force curve measurements and the actual deflection amount, the set value for the maximum value of the deflection amount can be adjusted so that these differences are eliminated.

### Modifications of Embodiment

(1) In the above-described embodiment, when measuring a force curve, the set value for the maximum value of the deflection amount is adjusted based on differential data that indicates the difference between the target value of the maximum deflection amount in the previously performed force curve measurements and the actual deflection amount. In that case, the term “previously” refers to one instance prior, as mentioned above, but it may encompass both one instance prior and several instances prior, as will be described below. For example, in cases where force curves are sequentially measured at multiple locations on the same sample, the configuration may be as follows. The differential data indicating the difference between the target value for the maximum value of the deflection amount during the first force curve measurement and the actual deflection amount is stored in memory 102 as reference data for previously performed force curve measurements. This reference data is stored as data from the previously performed force curve measurement. In subsequent force curve measurements, the set value for the maximum value of the deflection amount may be adjusted based on the stored reference data from multiple measurements.

As described above, the change of the set value for the maximum value of the deflection amount when measuring force curves may be performed in multiple subsequent force curve measurements, using the data from the first force curve measurement as a reference. Further, as in the above-described embodiment, the change of the set value for the maximum value of the deflection amount when measuring a force curve may be performed each time a force curve is measured, using the data from the immediately preceding force curve measurement as a reference.

(2) The force curve is composed of data that indicate the relation between the distance between the sample S and the tip portion 121 of the cantilever 12 and the force acting between the sample S and the cantilever 12. In the above-described embodiment, when measuring the force curve, the deflection amount D of the cantilever 12 is detected as the data for identifying the force acting between the sample S and the cantilever 12. However, not limited to the above, as the data for identifying the force acting between the sample S and the cantilever 12, the force acting on the sample stage 14 or the force acting on the cantilever 12 may be detected. As described above, the data indicating the relation between the force acting between the sample S and the cantilever 12 when measuring the force curve can be any data that can identify the pressing amount when pressing the cantilever 12 against the sample S.

(3) The method for measuring a force curve when the maximum value of the deflection amount D shown in FIG. 5 and FIG. 7 exceeds the target value DT can also be applied to the situation where a pulling force acts on the cantilever 12, as shown in the section (b) in FIG. 3. Further, the method for measuring the force curve when the maximum value of the deflection amount D shown in FIG. 6 and FIG. 7 falls short of the target value DT can also be applied to the situation where a pulling force acts on the cantilever 12, as shown in the section (b) in FIG. 3.

(4) As a device for changing the distance between the sample S and the tip portion 121 of the cantilever 12, either only the Z-directional actuator 141 that moves the sample stage 14 in the Z-direction, as shown by the solid line in FIG. 1, only the movable support device 13 that moves the cantilever 12 in the Z-direction as shown by the dashed line in FIG. 1, can be used, or both devices may be utilized.

(5) The control for changing the set value for the maximum value of the deflection amount when measuring the force curve may be performed on the condition that the differential data indicating the difference between the target value for the maximum value of the deflection amount in the previously performed force curve measurement and the actual deflection amount is greater than “0.” For example, when such differential data is of such a small value that it does not adversely affect the accuracy of the force curve measurement, the control to change the set value of the maximum deflection amount may not be executed. Further, such a threshold may vary depending on the type of the sample to be measured.

(6) The control for changing the set value of the maximum deflection amount when measuring the force curve may be performed either only when the maximum deflection amount D, as shown in FIG. 5 and FIG. 7, exceeds the target value DT, or only when the maximum deflection amount D, as shown in FIG. 6 and FIG. 7, falls short of the target value DT. It is not required to execute the control in both situations, allowing for selective operation based on specific conditions.

(7) When measuring a force curve, an example was described in which data including the data of the target value for the maximum value of the deflection amount at the time of the current force curve measurement, the data of the detection value of the actual deflection amount, and the set value for the maximum value of the deflection amount are stored in the memory 102. However, not limited to this, either instead of or in addition to the data of the target value for the maximum value of the deflection amount at the time of this force curve measurement and the data of the actual detected deflection amount, differential data indicating the difference between the target value for the maximum value of the deflection amount in the force curve measurement and the actual deflection amount is stored in memory 102 may also be stored in the memory. As described above, in the case of measuring a force curve, as the data for the current force curve measurement, any data that can identify the differential data showing the difference between the target value for the maximum value of the deflection amount during the measurement of the force curve and the actual deflection amount may be stored.

### [Notes]

The scanning probe microscope of the present disclosure (scanning probe microscope 1) has the following features

(1) A scanning probe microscope is provided with a sample stage (sample stage 14) configured to place a sample (sample S) thereon, a cantilever (cantilever 12) provided with a probe (probe 11), and a control device (control device 100). The cantilever (cantilever 12) is positioned to face the sample stage (sample stage 14). The control device (control device 100) is configured to control a pressing amount of the cantilever (cantilever 12) against the sample (sample S) to a target value (target value DT, deflection amount D1, D5) based on a set value (set value DS1, DS2) of the pressing amount, when measuring a force curve, and change the set value (the set value DS1 to the set value DS2), based on differential data (deflection amount D3, D7) indicating a difference between the target value (target value DT, deflection amount D1, D5) in a previously performed force curved measurement and an actual pressing amount (deflection amount D2, D6), when measuring the force curve (Step S7).

According to this configuration, when measuring the force curve, based on the differential data (deflection amounts D3, D7) indicating the difference value between the target value (target value DT, deflection amount D1, D5) and the actual pressing amount (deflection amount D2, D6) in the previously performed force curve measurement, the control device (control unit 100) changes the set value (the set value DS1 to the set value DS2) (Step S7). Therefore, the difference between the target value (target value DT, deflection amount D1, D5) and the actual pressing amount (deflection amount D2, D6) when pressing the cantilever (cantilever 12) against the sample (sample S) can be reduced.

(2) The control device (control device 100) changes the set value (set value DS1) to a new set value (set value DS2) to ensure that the actual pressing amount (deflection amount D2, D6) becomes equal to the target value (target value DT, deflection amount D1, D5) based on the differential data (deflection amount D3, D7) (Step S7).

According to this configuration, the control device (control device 100) changes the set value from the set value (set value DS1) to a set value (set value DS2) at which the actual pressing amount (deflection amounts D2, D6) becomes the target value (target value DT, deflection amounts D1, D5) based on differential data (deflection amounts D3, D7) (Step S7). Therefore, it is possible to make the actual pressing amount (deflection amount D2, D6) become equal to the target value (target value DT, deflection amount D1, D5).

(3) The control device (control device 100) reduces the set value (from set value DS1 to set value DS2) when the actual pressing amount (deflection amount D2) is greater than the target value (target value DT, deflection amount D1) (Steps S4, S7).

According to this configuration, the control device (control unit 100) reduces the set value (from set value DS1 to set value DS2) when the actual pressing amount (deflection D2) exceeds the target value (target value DT, deflection amount D1) (Steps S4, S7). Therefore, it is possible to adjust the set value (DS1) to ensure that the actual pressing amount (deflection amounts D2, D6) becomes equal to the target value (target value DT, deflection amounts D1, D5).

(4) The control device (control device 100) increases the set value (from set value DS1 to set value DS2) when the actual pressing amount (deflection amount D6) is less than the target value (target value DT, deflection amount D5) (Steps S6, S7).

According to this configuration, the control device (control unit 100) increases the set value (from set value DS1 to set value DS2) when the actual pressing amount (deflection D6) is less than the target value (target value DT, deflection amount D5) (Steps S6, S7). Therefore, it is possible to change the set value (DS1) so that the actual pressing amount (deflection amounts D2, D6) becomes equal to the target value (target value DT, deflection amounts D1, D5).

(5) The control device (control device 100) stores data capable of identifying the differential data (deflection amount D3, D7) when the force curve is measured (Step S9), and then adjusts the set value (from set value DS1 to set value DS2) for a subsequent force curve measurements based on the differential data (deflection amount D3, D7) identified by the stored data (Step S7)

According to this configuration, since the control device (control unit 100) stores data capable of identifying differential data (deflection amounts D3, D7) upon measuring the force curve (Step S9), and adjusts the set value (from set value DS1 to set value DS2) for subsequent force curve measurements based on the differential data (deflection amounts D3, D7) identified by the stored data (Step S7). Therefore, it is possible to adjust the set value (from set value DS1 to set value DS2) based on the differential data (deflection amount D3, D7) identified from the data stored during the force curve measurement.

(6) The control device (control device 100) stores data capable of identifying the differential data (deflection amount D3, D7) each time the force curve is measured (Step S9), and changes the set value (from set value DS1 to set value DS2) based on the differential data (deflection amount D3, D7) identified from the data stored in an immediately preceding force curve measurement each time the force curve is measured.

According to this configuration, the control device (control unit 100) stores data capable of identifying differential data (deflection amounts D3, D7) upon measuring the force curve (Step S9). For each subsequent force curve measurement, it adjusts the set value (from set value DS1 to set value DS2) based on the differential data (deflection amounts D3, D7) identified from the data stored in the immediately preceding force curve measurement (Step S7). Therefore, each time the force curve is measured, it is possible to reduce the difference between the target value of the pressing amount (target value DT, deflection amount D1, D5) and the actual pressing amount (deflection amount D2, D6).

Note that the embodiments disclosed here should be considered illustrative and not restrictive in all respects. It should be noted that the scope of the present invention is indicated by claims and is intended to include all modifications within the meaning and scope of the claims and equivalents.

### DESCRIPTION OF REFERENCE SYMBOLS

S Sample, 11 Probe, 14 Sample stage, 12 Cantilever, 100 Control device, 1 Scanning probe microscope

1. A scanning probe microscope comprising:
a sample stage configured to place a sample thereon;
a cantilever provided with a probe; and
a control device,
wherein the cantilever is positioned to face the sample stage, and
wherein the control device is configured to
control a pressing amount of the cantilever against the sample to a target value based on a set value of the pressing amount, when measuring a force curve, and
change the set value based on differential data indicating a difference between the target value in a previously performed force curve measurement and an actual pressing amount, when measuring the force curve.

2. The scanning probe microscope as recited in claim 1,
wherein the control device changes the set value to ensure that the actual pressing amount becomes equal to the target value based on the differential data.

3. The scanning probe microscope as recited in claim 1 or 2,
wherein the control device reduces the set value when the actual pressing amount is greater than the target value.

4. The scanning probe microscope as recited in claim 1,
wherein the control device increases the set value when the actual pressing amount is less than the target value.

5. The scanning probe microscope as recited in claim 1,
wherein the control device
stores data capable of identifying the differential data when the force curve is measured and
changes the set value in a subsequent force curve measurement based on the differential data identified by the stored data.

6. The scanning probe microscope as recited in claim 5,
wherein the control device
stores data capable of identifying the differential data each time the force curve is measured, and
changes the set value based on the differential data identified by the data stored in an immediately preceding force curve measurement each time the force curve is measured.
